(19) United States
(12) Patent Application Publication
(10) Pub. No.: US 2006/0172697 A1
(43) Pub. Date: Aug. 3, 2006

(54) Information broadcasting and support system using mobile devices

(76) Inventors: Fernando Planas Gallego, Las Rozas (ES); Luis Del Ser Toral, Las Rozas (ES); Juan Carlos Alvarez Garcia, Las Rozas (ES)

Correspondence Address: JACOBSON HOLMAN PLLC, 400 SEVENTH STREET N.W., SUITE 600, WASHINGTON, DC, 20004, US

(21) Appl. No.: 11/140,882

(22) Filed: Jun. 1, 2005

(30) Foreign Application Priority Data
Feb. 2, 2005 (ES) 200500192

(51) Int. Cl. H04H 1/00

(52) U.S. Cl. 455/3.01

(57) ABSTRACT

A system to provide media to broadcast informational advertising or any other kind of ad campaign by using portable devices carried by users, such as mobile telephones, PDA devices, hybrid devices and, in general, any device that permits a multimedia reproduction of content received in the device, either in the form of a call or in the form of a message. The system provides for the implementation of an application in the mobile device, whose application involves a call management and campaign broadcast module, a configuration and storage management module, and server data communication modules. The interrelationships between the application modules and the modules in the mobile device are done through interfaces. The system allows users to configure parameters and also incorporates point generating media depending on the broadcast performed.

### BACKGROUND AND SUMMARY OF THE INVENTION

The present invention relates to an information broadcasting and support system using mobile devices that contributes essential novel features and notable advantages compared to known media systems that are using currently available techniques for the same purposes.

More specifically, the present invention covers systems and devices that allow for informational, advertising or any other type of content to be broadcast using mobile devices that act as the broadcasters of such content using the multimedia capabilities those devices have (screen and speakers) and involves systems that allow points from the broadcasts to be measured, tallied and exchanged and then stored in storage media.

More specifically, the invention relates to the use of mobile devices that, in the hands of their users and when the users want, employ the multimedia capabilities (including image, video and/or sound) of these devices to broadcast advertisements when calls are received.

The invention's general field of application is the industrial sector engaged in implementing systems and media to be used as tools to broadcast and disseminate information.

To make this broadcasting function possible, the present invention defines an application that is installed in the targeted mobile device and serves three purposes:
it is a multimedia advertisement download manager (ad campaigns, announcements, etc.) that lets the server consult available ad campaigns.
it is an incoming call and message manager that detects incoming calls and messages and controls the telephone's multimedia elements (speaker, screen) from the moment the call is received at the terminal until the user picks up the call, or for a determined length of time when any kind of message reaches the device, and
it is an indirect calculator of the effect of the advertisement by measuring the length of time the telephone's multimedia elements (speaker and screen) are activated and then translating this information into points that are stored safety in the devices and transmitted to the server.

### BACKGROUND OF THE INVENTION

The use of mobile devices capable of receiving notifications (any kind of message) or calls via telephone has been used as an advertisement channel to conduct one-to-one marketing campaigns. In these types of ad campaigns, a targeted public is selected to whom a Multimedia SMS message is sent to draw a user's attention to the telephone. This kind of ad marketing runs the risk of being labeled SPAM if it is used indiscriminately. In practice, the ads mainly fall under three categories, which are:
offers the mobile phone operator chooses for its customers, like discounts for sending messages, new services available, etc.;
advertisements/informational messages about forums that the phone user has previously signed up for (sports, musical forums, etc.) or has shown an interest in (phone user has sent an SMS/MMS in the past asking for some kind of information), and
welcome messages when a user enters an operator's coverage area. This is for SMS messages at the time the mobile phone is activated when we arrive to an airport in a country other than the one where we receive informational SMS messages from operators working in conjunction with our telephone operator in our country of origin.

The use of ring tones for a mobile phone has also been used in advertising as a way to identify a brand. This is the case with announcements from a Spanish Mobile Telephony operator, (Mobile Telephony) broadcast on television, when a person who took a long time to answer the mobile phone got polyphonic sounds (which at that time was a novelty) so that everyone near the phone user could hear the sound and could notice that this person was carrying a state-of-the-art device (in that instance, i-mode).

Ring tones of known or curious melodies or ones that phone owners want are also the norm, and there are business models that exploit these services. In this case, the tones are reproduced on the phone when a call is received and can be heard by the user and by those around him or her. The tones can be synthesized (monophonic or polyphonic), or they can be “real” (reproduction of a sound).

As of now, previous functions for downloading content and sending ad information have been designed for users who are the final recipients and did not take into consideration the user as a participant in broadcasting the content.

Advertisements from other media produce effects on the target public in different situations:

advertisements on television are broadcast along with programming and are directed primarily to the home and mainly affect the people sitting in front of the television set;
advertisements on the radio are broadcast along with programming and have an impact and are heard in places where people listen to the radio (home, car, work, etc.);
advertisements on billboards and panels affect the public passing by them (on highways, streets, buildings) or the people looking at images transmitted on their television set (such as ad panels at soccer stadiums or other similar facilities, sports related or otherwise);
advertisements in the written press primarily affect the reader of the printed medium;
other written advertisements are directed at members of a household and usually reach the person by way of the mailbox;
lastly, advertisements presented and broadcast using electronic media, such as over the Internet, personally affect surfing the web or reading emails, news forums, etc.

This invention exploits the capability of the operating or programming system of mobile devices, along with their multimedia capabilities, to use them as a tool to advertise near where the device is located.

### SUMMARY OF THE INVENTION

A primary object of the invention is the provision of a system that allows mobile devices to be used to broadcast informational and ad content through the use of the multimedia features of the device (screen and speaker). Ad content is broadcast when an incoming call or message is received, and the device notifies the phone user by emitting a sound that is loud enough for people near the user of the telephone to notice it.

The term “mobile devices” as used in this document should be understood to mean telephones, PDA devices, hybrid devices and, in general, any portable device that can be used for multimedia reproduction (sound, images and/or video).

The length of ad reproductions may be predetermined when the notification involves messages (SMS, MMS, etc.), or it may be unspecified and dependent on the user, such as when calls are received, where the advertisement is not reproduced until the user picks up the incoming call or it is cut off, either because the originator of the call hangs up or the operator's predetermined answering system is activated.

Ad reproduction is done using the device's available multimedia resources, specifically:
The screen, for image or video reproductions, and
The speaker, for tone or sound reproductions.
Reproduction can only be done by one of the previously mentioned resources or by several of them simultaneously.
Ad contents are downloaded into the device in the form of tones/images/video designed to broadcast ad information, i.e.:
a sound associated with a specific brand name;
a spoken message;
a jingle associated with an ad;
a video of an advertisement, with or without sound;
a brand's logo, or
a synthesized stationary or moving image on the device's screen.

The effect the ad has is produced anytime at anyplace, because incoming calls or messages to the phone generally come about arbitrarily and are not dependent on the receiver. When a call is received, the predefined ad content is reproduced, and this way it affects a varying number of people depending on the circumstances the phone user is in. That way, there are multiple scenarios of use, such as:
at the workplace, the device can be positioned on top of the table where a meeting is being held, and its screen can be viewed by some of the members of the work team;
on the bus, when the device we are carrying in our pocket sounds, its sound can be heard by the people around us;
at the beach or pool side, it can affect people nearby,
at the soccer field;
walking down the street;
at a restaurant;
anywhere else.

This way, the system the invention proposes allows the effect of an advertisement to be the most suitable place, which is specifically the place where people are. This is true because the mobile device is used as the element to broadcast the information, and the worldwide market share of mobile devices is above 70%.

The system is suitable for use by any mobile device that is positioned near the people the ad is targeting, so it can be equally applied to stationary mobile devices, in vehicles, bicycles, etc.

To achieve the above described effect of ad broadcasting using mobile devices, this invention comes into play in the form of an application that is developed in a programming language and is to be installed and executed on the aforementioned mobile devices. Once this application is installed on the mobile devices of multiple users and used by them, it enables an ad broadcasting service to begin.

The service is made up of a server which users access by way of the aforementioned application to download ad contents and to notify users of the points obtained from users using the mobile telephone's broadcasting service.

The central object of the invention is basically the application that is installed on the mobile devices and that enables the content broadcasting service to be used. This application permits access via a wired or wireless procedure (for example: data cables, infrareds, Bluetooth interface, GPRS, UMTS, etc.) to a content server that acts as an ad campaign server. These campaigns are obtained or converted into a format reproducible by the multimedia technologies of the mobile devices (different format tones, images, MMS, EMS, video, etc.).

The application allows users to connect to the server, after they have been adequately authenticated, and access ad contents.

The application allows users to choose the ad profile so they can select the type of campaign or even the specific campaign they want to broadcast. The application could also work with campaigns that are predefined by service providers, so that they can be downloaded without the user's involvement or supervision, except as required to initiate the connection, if necessary.

Users, via the application cited above, can review the defined features of the campaign or campaigns they want to promote with their mobile phones and store in the server. Once a campaign has been selected, it is downloaded and stored in the mobile device.

Information about the availability of new campaigns can be provided by the server through a push mechanism that permits the download process to begin from the server.

Ad Broadcasting when Incoming Calls or Messages are Received:

Once the application has been installed, it is activated automatically when calls are received and until the user picks up the call or it is terminated for any other reason. For messages, the application allows an advertisement to run for a predetermined length of time.

When the application is activated, it takes control of the screen/speaker, or both, of the mobile device that is being activated, and the ad campaign is reproduced according to the application's configuration.

While the campaign is being reproduced, the application also calculates the effect the advertisement has, taking into account the parameters with which it is configured. This way, the calculation can vary depending on the medium that is reproduced (video, sound, etc.), the length of the reproduction, speaker volume in the event sound is used, call frequency (for example, especially calculating malicious calls done successively and that come from the same caller).

The application is not intrusive and is automatically terminated when the user picks up the call or, for messages, after a predetermined length of time.

When broadcast has concluded, a point value is calculated and stored in the device.

Local Configuration of Campaigns and how they Work:

The application allows for local configuration (in the device) of the operating ad mode and for the configuration of other preferences in order to perform actions such as:
review downloaded campaign features and preview them;
automatically select the campaign to be broadcast or personally select a campaign from ones that have been downloaded;
type of multimedia reproduction selected for campaigns that permit it, such as image or video alone or just sound.
select campaign reproduction volumes;
association of campaigns with the type of incoming notification (calls, messages);
association of predetermined campaigns with specific callers or calling groups;
creation of predetermined broadcast profiles with some of the aforementioned features and configuration of mechanisms to be able to pass them on from one person to another (for example, by associating them with modes of operation of a mobile phone; meeting, normal, . . . ), and
review of points accumulated from broadcasting the contents.
   Safe Storage of Points and Review of Points Accumulated

The application assigns a number to the data calculated using a procedure and stores them in the mobile device. The application also allows users to view the number of points a user, as an ad broadcaster using the application, has accumulated up to a specific time.

Sending Points to the Server

The application allows users to connect to the remote server for notification about points. When points are notified satisfactorily, the partial point counter is set to zero.

The application can have established limits so that if a predetermined number of points is reached and the server has not been notified, the application stops counting points until they are reported to the server via a connection.

According to the invention, the main features defining the proposed system can be summarized as follows:
it uses the mobile device as an advertising mechanism for the specific user of the application and also for those located around him or her;
sound reproduction is done at a loud enough volume so that it can be heard around the telephone user;
the device's user can activate and deactivate the system at will so that the mobile device can be used normally, without generating any ad effect. This allows it to be used under the same conditions as the device was used before the invention's system was installed on it: meetings, leisure time, etc.
users also decide the ad profile, or even which specific ad campaign, they want to broadcast;
the application does not interfere with the phone's normal operation, and it (and therefore the advertisement coming from it) stops operating when the call is picked up;
it allows for advertising information to be broadcast at the closest point possible to people, since they are the targets of the advertisement;
the moment broadcasting takes place cannot be predicted since it is activated when a call or message is received by any telephone in the area. Due to this, the advertisement has more of an impact;
ad campaigns that can be broadcast over the device are obtained using the application, and the server is accessed by using a connectivity device (wired or wireless);
users accumulate points while the ad is being broadcast around them. These points are calculated according to different criteria and are stored in the device as encrypted information, and
users can use the application to transmit information to the server about accumulated points and cash them in and exchange them.

### BRIEF DESCRIPTION OF THE DRAWINGS

The features of the invention can be better understood with the help of the attached drawings, in which:

FIG. 1 is a schematic representation of the multiplicator effect experienced by broadcasting the advertisement when the application discussed in the invention is installed on the devices of multiple users, and

FIG. 2 represents the general diagram of the application's modules and the interactions among the various elements of the application and the device.

### DETAILED DESCRIPTION OF THE PREFERRED EMBODIMENTS

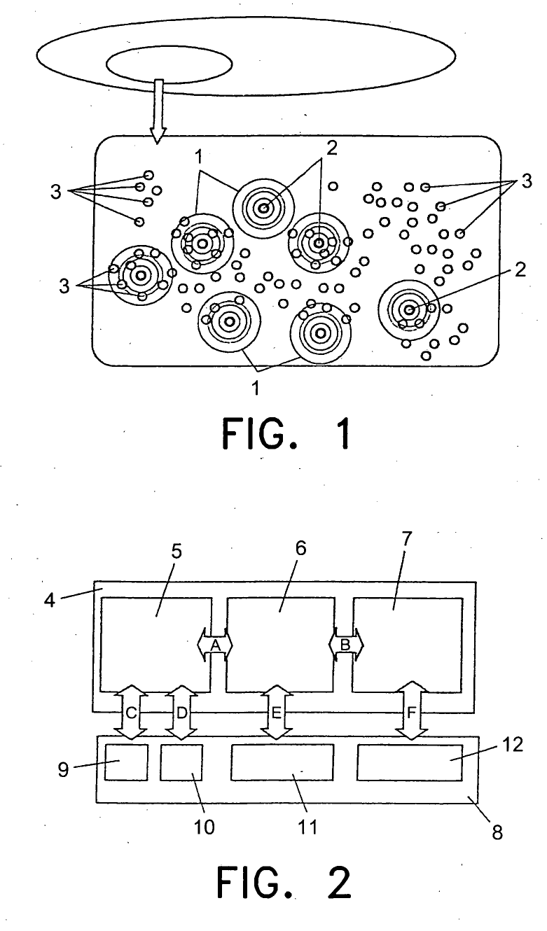

As indicated above, the detailed description of the preferred embodiment of the invention is done with the help of the attached drawings. So, looking at FIG. 1 first, a schematic representation of the broadcasting effect of the ad contents received over the mobile phones of different people is shown. As can be seen in this Figure, there are several circular areas marked 1 of a predetermined radius making up the range of influence of the person carrying a mobile device that is receiving information or ad contents, with person 2 occupying the center of zone 1, respectively. Other people, marked number 3, are moving in and out of the different areas and sometimes come into the areas of influence 1 of a mobile device that is receiving, at a given moment in time, some ad content, which obviously means that these people 3 are being reached by the messages received via these mobile devices, and therefore they are aware of the different information that is being transmitted.

FIG. 2 is a schematic representation of the modules that make up the application installed on the mobile device and the interactions between the various elements of the application and the device. In general, numerical reference 4 graphically indicates the application of the invention to broadcast ad contents and houses inside of it the main modules of the application, consisting of module 5, which is a call and campaign broadcast manager, module 6, which is an application configuration and storage manager, and module 7, which enables data communication with the server. The application is installed on mobile device 8, which has the normal elements of multimedia reproduction materialized in block 9, module 10 for incoming calls and incoming messages on the mobile device, module 11 for storage, and module 12 for data communication. There are interfaces between the aforementioned modules that allow for the various interactions and processes needed to implement the different functionalities to take place. These have been labeled “A” to “F” in the Figure.

According to the invention, module 4 represents the application developed and installed on the mobile device and stores the different main modules whose activation is going to be described below. Thus, call management and campaign broadcast module 5 is in charge of broadcasting the ad content by detecting incoming calls or messages and using the speaker and screen of the mobile device to reproduce the ad campaign. Call management and campaign broadcast module 5 detects an incoming call or message in the mobile device through communication interface “D” with incoming call and message module 10 and interacts with the multimedia reproduction elements 9 of the mobile device 8 through interface “C”, using them to reproduce the campaign's content (image, tones, video, . . . ) recovered through communication interface “A” with application configuration and storage management module 6. This module is in charge of answering the call (detected through interface “D” mentioned above) or after a preset period of time in the case that messages are received, and the campaign is interrupted in the multimedia elements 9 of the mobile device 8.

On the other hand, application configuration and storage management module 6 is in charge of configuring the different parameters of the application and of storing them in the device. This module allows users to review the contents of the campaigns downloaded in the phone and their features: type of points they generate, their category or profile, type of resources the device uses (speaker, screen, . . . ). In addition, it allows users to review the points accumulated from broadcasting ad campaigns and also provides access to and manages data storage in the device in the form of encrypted information for the rest of the application.

As for the application's server data communication module 7, it is the module that is responsible for data communications with the server via the different data communication mechanisms available on the mobile device 8, facilitating the establishment of the connection with the server. It is responsible for authenticating the user of the application in the remote server and manages communications with the various protocols possible, managing data recovery and transmission from and to the server and making these functions available to the rest of the modules through interface “B”.

As for the mobile device marked number 8 in FIG. 2, it is the physical support on which the application is installed and incorporates the various elements and modules that are accessible by a given procedure (for example, APIs) so they can be configured, controlled or consulted by remote modules implemented in the application of ad broadcasting 4, the object of the invention. Along these lines, the different modules can be described as follows:
Multimedia reproduction module 9: it is made up of the device's elements that are going to be in charge of reproducing the campaigns. It basically involves the screen and speaker over which the contents of the campaigns are reproduced;
Incoming calls and messages module 10: this is made up of the elements that permit calls entering the device 8 to be detected or a new message of any kind to be received. These elements provide some kind of device for consultable detection or that notifies users that these events have occurred;
Storage module 11: this module is a storage system in any format and the structure that allows information and data generated by the application to be stored. It can consist, for example, of a card system, a database included in the device, . . . , etc., and
Data communication module 12: this module permits data communications to be established with remote elements such as servers or other devices using any existing technology (Bluetooth, GPRS, UMTS, etc.). It is available over the different APIs that can be invoked from application 4 to transmit and receive data.

As for the system interfaces labeled “A” to “F” in the Figure, they permit the follow interactions:
Interface “A”: it is the campaign and points access interface and is located between call management and campaign broadcast module 5 and application configuration and storage module 6. It allows the campaign to be advertised and its characteristics to be recovered by the aforementioned module 5. It also allows for the recovery of general configuration parameters of the application by the campaign broadcast module 5 and also allows the points acquired for the call or message following broadcast to be transmitted and stored by storage management module 6;
Interface “B”: it is the interface for receiving campaigns and transmitting points and interconnects configuration and storage management module 6 and communication module 7 to the server. This interface facilitates the recovery of campaigns and data housed in the remote servers or elements that support the service and facilitates the possibility of transmitting data and information to those remote servers and elements that support the service;
Interface “C”: it is the interface between the application access and screen and speaker elements 9 of the mobile device 8, and its purpose is to permit the configuration and control of the screen, to permit the configuration and control of the speaker, and to permit the reproduction of the contents by these elements;
Interface “D”: it is the incoming call and message reception interception interface. It is located between application module 5 and incoming call and message module 10 of the mobile device 8. Its purpose is to notify when a call is received, when a call has ended or when the device is picked up and to notify when a message is received in the device;
Interface “E”: it is the storage management interface. It is located between application configuration and storage management module 6 and storage module 11 in the device. It allows contents and data to be stored by the application in the device and also allows the application to recover contents stored on the device;
Interface “F”: lastly, this interface is in charge of data communication with the server and interconnects application module 7 (the module in charge of enabling data communication with the server) to module 12 of the mobile device 8 (data communication module). The interface enables the establishment and management of data connections with elements and servers outside of the device and also permits the transmission of data to the aforementioned elements and servers outside of the device.

Now that the various modules making up application 4 implemented by the invention and their interrelationships with the various modules of mobile device 8 have been described, the system's operating features will now be described. Along these lines, according to the invention, the general flow of operation of the application can be summarized with the following phases:
Application 4 is installed in device 8 of the user;
Application 4 allows users to connect via data to the service's servers, through which ad contents can be downloaded;
the user can configure the application's operating features through the user interface the application provides and can be accessed by various media (icons, command lines, etc.);
the next time a call is received, the sound and screen show those downloaded contents, and the user begins to accumulate points. This operation is transparent and is done automatically, without interrupting the normal use of the phone. When a call is answered, the ad contents stop being transmitted. For messages, ad contents are only reproduced for a preset period of time.
users can review how many points they have in the phone by consulting the application and, if they want to, they can send them to the server and convert them into “exchangeable points”;
users can change the ad campaign(s) being transmitted by connecting to the server. In the data notification, the service can tell a user about new campaigns available according to the user's profile;
lastly, the use of the application by the telephone user is voluntary and can be deactivated, but the accumulation of points is only generated if the application is activated.

Regarding the operation defining the essential nature of the invention's application, it can be summarized in a group of the following operations:

Ad campaign downloading;

campaign broadcasting;

review of configuration, parameters and points;

modification of configuration, parameters and points, and

sending points to the server.

These operations can be defined by the interactions involving the various modules which detail the principal operation. During interactions, communication between modules is established using the defined interfaces and generally involves the exchange of data. Interactions are produced due to events generated by the user using the application voluntarily, through the user interface of configuration module 6 or by outside events, like the appearance of an incoming call or the receipt of a message.

Below is a detailed description of the various interactions, with an allusion to the different modules of the system implicated in each:

Downloading New Ad Campaigns

The download of available ad campaigns is done by the interactions described below:

Interaction I-a:

The user of mobile device 8, using the interface provided by communication module 6, requests data communication with the remote server. To do this, the user uses interface “B” to communicate with the module of application data communications module 6, and uses interface “F” to be able to use the communications resources provided by data communication module 12. With these actions:
the user is authenticated and authorized to access the information, and
the user sends a request to download or view the features of available campaigns on the server.
   Interaction I-b:

Information about the available campaigns or the features requested are recovered from the server using communications module 7, which uses interface “F” to access the communications resources of the mobile device integrated in its data communications module 12. The recovered information can be viewed through module 6 and interface “B”. Finally, the data to be stored in the storage system of storage device 11 are management through configuration and storage module 6 through interface “E”.

Campaign Broadcasting:

The ad campaign itself involves the three interactions described below:

Interaction II-a

When a voice call is received in the device or a message is received in incoming call and message module 10, it is detected or reported through interface “D” to call management and campaign broadcast module 5. This same operation takes place when the incoming call is interrupted, either because the telephone is answered or because the call is interrupted before being answered.

Interaction II-b

Call management and campaign broadcast module 5 chooses the campaign that is to be transmitted, along with the characteristics of the reproduction, asking configuration and storage management module 6, through interface “A”, for the stored data. Configuration and storage management module 6 recovers them from storage module 11 of mobile device 8, using interface “E” to do this, and supplies them to ad broadcast module 5, which, through interface “C”, activates multimedia resources 9 of mobile device 8.

Interaction II-c

Call management module 5 calculates the points for the last ad broadcast and requests storage management module 6, through interface “A”, to store the calculated points. This last mentioned module 6 stores them in storage device 11 of the mobile device 8, using interface “E” to do this. After this last interaction, the application resets to receive another call or to be used by the user for other functions such as the parameter configuration function.

Review of Configuration, Parameters and Points

This can be done using the interaction described below:

Interaction III-a

Using this interaction, the user can configure, by accessing configuration and storage module 6, through the user interface, the particular features of the campaign stored in storage device 11 and the data regarding points from the most recent broadcasts, and the cumulative totals. To do this, configuration module 6 uses interface “E”.

Sending Points to the Server

Sending points or other information (surveys, forms, personal data) to the server can be done by the user by using the interaction described below:

Interaction IV-a

The user employs the user interface of configuration module 6, which allows the user, on the one hand, to access the data stored in storage device 11, through interface “E”, and, on the other hand, to request communications management module 7, through interface “B”, to send the points. The last one does this through the communication facilities of data communication module 12, using interface “F” to do this.

As will be understood, the implementation of the application proposed by the invention on a mobile device like a mobile telephone or similar device requires that the latter meet some minimum requirements that are mentioned below:

Call management access

Screen control access

Speaker control access

Storage system access

Communications access

Transparent start-up to user

Possible platforms for performing the application involved in the invention include, among others, mobile devices based on:

Symbian

Microsoft

BlackBerry

Mac Os

Linux

Brew

Java

any other Operating System or device that may become available

With support for OSA Parlay applications

It is not believe it is necessary to make the content of this description more extensive for an expert in the subject matter to understand the scope and advantages of the invention, as well as to develop and put the invention's object into practice. Nevertheless, it should be understood that the preferred use of the invention has been described, so it may be susceptible to modifications, without this implying any limitation to its scope.

1. An information broadcast and support system using mobile devices, especially applicable to the broadcasting and propagation of content involving information of any kind emanating from a remote server, the system comprising:
at least one mobile device having a multimedia reproduction module, the mobile device being used as a broadcast medium to disseminate content to people near where the carrier of the at least one mobile device is located; and
a software application in the at least one mobile device consisting of
(a) a call management and campaign broadcast module for broadcasting the content by detecting incoming calls and using the multimedia reproduction module of the at least one mobile device to reproduce the content;
(b) an application configuration and storage management module for answering an incoming call and for configuring the different parameters of the application and storing them in the at least one mobile device; and
(c) a data communication module for data communications with the server and for facilitating connection with the server.

2. The system, according to claim 1, wherein the interrelationship among the various modules of the application and between them and the modules of the mobile device is done via interfaces, distributed as follows:
interface (A) interconnects the call management module to the configuration and storage management module;
interface (B) interconnects the configuration and storage management module to the server data communication module;
interfaces (C and D) interconnect the call management module of the application to the multimedia reproduction module, and to incoming call and message detection module in the mobile device, respectively,
interface (E) interconnects the configuration and the storage management module of the application to a storage module of the mobile device, and
interface (F) interconnects the communications module included in the application to the communication module located in the mobile device.

3. The system, according to claim 1, wherein the application installed in the mobile device carries out the following operations:
recovering configurations of remote servers;
storing those configurations on the at least one mobile device;
recovering contents from informational, advertising or other kinds of ads in different formats of remote servers;
storing downloaded contents on a storage device located in the at least one mobile device;
detecting receipt of a call or message coming into the at least one mobile device; and
detecting when a call is interrupted or is answered by the user of the mobile device;
accessing the multimedia elements of the device and configuring its features for broadcasting the contents during the period in question depending on the kind of telephone connection established;
reproducing of the multimedia elements of image, sound, video, etc. in different formats;
calculating points regarding the use of the application for broadcasting purposes;
preventing fraudulent use of the application to prevent the generation of points without having performed the broadcast function;
storing of information relative to the points for using the application as a medium to broadcast informational or advertising content, and
transmitting information regarding points and other data to the remote server.

4. A system, according to claim 3, wherein the application provides that the functionality of broadcast informational or advertising content in the at least one mobile device is interrupted when, dealing with an incoming call on the device, the user picks up the call.

5. A system, according to claim 3, wherein the application provides that the functionality of broadcasting the informational or advertising content is carried out during a predetermined period of time when a message is received in the at least one mobile device.

6. A method for information broadcast and support using a mobile device as an advertising beacon, especially applicable to the broadcasting and propagation of content involving information of any other kind emanating from a remote server, the method comprising the steps of:
using an application installed on the mobile device;
recovering from the remote server, the informational, advertising or content of any nature related to one or more campaigns that are going to be broadcast;
using the time from when notice of an incoming call is received in the device until the user picks up or the call is disconnected for any other reason in order to broadcast the ad content using multimedia elements in the mobile device;
calculating points in terms of broadcasting the application;
storing accumulated points in the mobile device or in outside servers;
notifying about points to remote servers in order to transport them into “exchangeable points”, and
configuring the features of the application.
